(19) United States
(12) Patent Application Publication
(10) Pub. No.: US 2024/0085549 A1
(43) Pub. Date: Mar. 14, 2024

(54) METHOD AND DEVICE FOR DETECTING CHANGES OF THE GEOMETRIC ARRANGEMENT, THE NATURE OR THE QUANTITY OF OBJECTS OR BODIES

(71) Applicant: REAL-CIS GMBH, Langen (DE)

(72) Inventors: Hubert JÄGER, Pullach (DE); Edmund ERNST, München (DE); Karl-Heinz SCHAINK, Oberhaching (DE)

(73) Assignee: REAL-CIS GMBH, Langen (DE)

(21) Appl. No.: 18/272,397

(22) PCT Filed: Jan. 10, 2022
(86) PCT No.: PCT/EP2022/050326

§ 371 Date: Jul. 14, 2023

(30) Foreign Application Priority Data
Jan. 26, 2021 (EP) 21153595.0

(51) Int. Cl. G01S 13/56; G01S 13/536; G01S 13/88

(52) U.S. Cl. CPC G01S 13/56; G01S 13/536; G01S 13/886

(57) ABSTRACT

The invention relates to a method and a device for the detection of changes of the geometric arrangement, the nature or the quantity of objects or bodies by means of sensors.

The invention relates to a method and a device for detecting changes of the geometric arrangement, the quality or the quantity of objects or bodies using sensors.

In particular, the invention relates to a method and a device which, in the case of changes in the arrangements or quantity of electrically conductive, dielectric or magnetically permeable objects or bodies within a defined perimeter or space, emits a signal which can be interpreted as detection of an event characterized by the changes.

The detection of changes in the geometric arrangements, the quality or the quantity of objects or bodies can be assigned to different fields of application.

A first group of applications requires continuous measurement and optional recording of changes in the geometric arrangements and quantity of objects or bodies. A second group of applications only requires an alerting signal as soon as a geometric arrangement of objects or bodies, or their quantity, changes.

A different set of applications, related to the monitored perimeter or space, is directed at the detection of endogenous causes of the changes in the geometric arrangements or the quantity of objects or bodies, this being opposed to the set of applications in which the changes in the geometric arrangements or the quantity of objects or bodies due to exogenous causes are of importance.

The detection of changes in the geometric arrangements, the quality or the quantity of objects or bodies can be implemented using different sensor systems, the functionality of which is based on different physical mechanisms.

Contact-based sensor devices are used, which detect and report changes in specially provided, usually electrical contacts. The disadvantages linked with these designs of the sensor system are, firstly, the need to attach the dedicated contacts in the monitored perimeter or space, which is costly on the one hand and on the other hand only allows a resolution for the detection of the changes in the arrangement which depend on the specific design of the objects or bodies, and the specific arrangement and density of the contacts.

Furthermore, sensor systems are used which detect and report the change in the electromagnetic waves that arise on account of the emission from the surfaces of the objects or bodies; for example, if the change in the arrangement relates to a human body entering the perimeter or space, these electromagnetic waves are the infrared radiation of the body heat. The disadvantage linked with these designs of the sensor system is that this sensor system only renders those changes detectable which are associated with the movement of objects and bodies that actively emit different electromagnetic waves from their surfaces.

Furthermore, sensor systems are used which detect and report changes in the reflections of electromagnetic waves from the surfaces of the objects or bodies within the defined perimeter or space. The disadvantages linked with these designs of the sensor system are that if the wavelength of the electromagnetic waves from the source of the waves irradiating the arrangement of the objects is chosen to be too short, which is to say the radiation is in the optical range, then not all corners of the arrangement are illuminated and changes in the arrangement or the quality of the objects or bodies remain hidden from the sensor system; or the wavelength of the electromagnetic waves from the source irradiating the arrangement of the objects is chosen to be too long and the resolution of the sensor system is too coarse and relevant relatively small changes in the arrangement, the quality of the objects or bodies remain undetected. Furthermore, the sensitivity and reliability of such sensor systems suffer if the wavelength used overlaps with that of the electromagnetic radiation emitted by the objects or bodies due to the quality and characteristics thereof. Additionally, the objects or bodies can be impaired by the radiation used for the sensor system and can be disrupted in terms of their function if they are electronic or electrical devices.

Analogous disadvantages arise if acoustic waves are used in echo sounder operation instead of the electromagnetic waves.

Another design option for such a sensor system for the portion of the applications that only require an alerting signal as soon and insofar as a geometric arrangement, the quality or the quantity of objects or bodies changes, lies in the detection and reporting of only changes at the perimeter or wall of the monitored space and the use of the observation of the perimeter or the wall to deduce that, as long as there are no changes to the perimeter or wall of the monitored space, no changes in the arrangement, the quality or the quantity of the objects and bodies within the space should be expected either.

Typical examples for this portion of the applications are sensor systems that are intended to improve manipulation security or “tamper proofing” for technical devices in a housing, cabinet or room, for example for data processing systems.

This can be implemented using capacitive sensors, which is to say the detection of a change in the electric field measurable at the perimeter, using inductive sensors, which is to say the detection of a change in the magnetic field measurable at the perimeter, using temperature sensors, which is to say detection of a temperature change at the perimeter, using vibration sensors, which is to say a detection of an acceleration at the perimeter, or by means of capacitive and/or ohmic measurements on conductor-permeated or current-carrying films to detect breaches to surfaces or the wall of the monitored space, for instance as described in [https://www.te.com/content/dam/te-com/documents/sensors/global/tamper-detection-sensors-solution-sheet.pdf].

The disadvantages linked with such designs of the sensor system are that the range of this sensor system is very limited, with the result that it may require many of these sensors to monitor a relatively large perimeter, that some of the penetrating bodies do not cause any response from such sensors, that for example penetrations are possible without causing any response from acceleration sensors, that the dimensioning and configuration of the modules from which the sensor system is constructed and which are required for the functionality of the sensor system depend heavily on the specific design of the arrangements of the objects in the space to be monitored, with the result that individual and not standardized and prefabricated components are therefore required to proceed, and that the outsmarting of the sensor system at the perimeter is sometimes too easy, depending on the exact implementation.

Finally, especially if a sensor system is designed for particularly high sensitivity, such designs of the sensor system are disadvantageous in that, within the scope of transporting the monitored housings, cabinets or rooms in which the arrangement of the objects within the space to be monitored is not changed, such a sensor system, on account of the accelerations, elastic deformations and possibly other influences, nevertheless misleadingly emit a signal as if the perimeter had been breached and a corresponding change in the arrangement, the quality or the quantity of the objects or bodies within the space to be monitored should be assumed.

The object of the invention is therefore that of providing a method and a device for sensitively and reliably detecting changes in the arrangement, the quality or the quantity of electrically conductive, dielectric or magnetically permeable bodies within a defined perimeter or space, which device gives off a signal for detecting the event characterized by the change, without these having the disadvantages of the devices and methods known from the prior art.

According to the invention, this object is achieved by the devices as claimed in the independent claims. Advantageous developments are specified in the respective dependent claims.

The invention in particular has the following advantages:
The detection of changes in a geometric arrangement, the quality or the quantity of objects is possible in an efficient and very sensitive way,
   since a signal processing module continuously compares the amplitudes of the electromagnetic wave-generating signals emitted by a transmitter and the signals received by a receiver, there is no need to attach dedicated contacts in the monitored perimeter or space,
   the methods according to the invention and the devices according to the invention can be constructed using commercially available transmitter and receiver modules without specific adaptations for the space to be monitored,
   changes in the arrangement of objects or bodies which are not actively radiating can be detected and reported,
   since the frequency of the waves emitted by the transmitter is chosen high enough so as not to disturb objects or apparatuses, optionally operating on electrical or electronic basis, within the space to be monitored but nevertheless achieve a high resolution, which is to say be able to detect and report even small geometric changes.
Since the wall encasing the space to be monitored has an at least partly electrically conductive or metallic structure, all corners of the arrangement of the objects can be illuminated by diffraction and reflections at the encasing at least partially electrically conductive or metallic structure, and since the frequency of the waves emitted by the transmitter is chosen so that all corners of the arrangement of the objects in the space to be monitored are illuminated by diffraction and reflections at the metallic structures of the casing, small geometric changes can already be detected and reported.
Since the signal processing module also continuously compares the phases of the electromagnetic wave-generating signals emitted by a transmitter and the signals received by a receiver,
   even small geometric changes can be detected and reported,
   various penetration or attack processes can be identified with high confidence. By way of example, the speed of a drill applied to the wall can be measured. Alternatively, it is possible to detect and report slight deformations of the casing which other sensors cannot detect or can only detect under very specific circumstances.
Since the electromagnetic waves emitted by the transmitter can not only be a continuous wave at a constant frequency but also have a modulation (e.g., frequency modulation) for a higher resolution, it is still possible to achieve a high geometric resolution of the detection without high-energy pulses.
Due to the fact that an energy store within the space to be monitored can maintain the operation of the device during an optionally required transport and the accompanying disconnection from the power supply network, the entire housing, cabinet or room to be monitored can be transported without the monitoring having to be interrupted to this end.
Due to the fact that the elastic or otherwise movable parts or parts of objects are fixed within the space to be monitored in such a way that movements during transport can no longer lead to changes, of order of the wavelength of the electromagnetic waves, in the pose or position of the objects or bodies within the space to be monitored, there is an increase in the robustness of the device for detecting changes in the arrangement, quality or quantity of objects or bodies since no misleading alarms due to vibrations during transport can be triggered in this way.

Details and features of the invention as well as specific exemplary embodiments of the invention will become apparent from the following description in conjunction with the drawings. In detail:

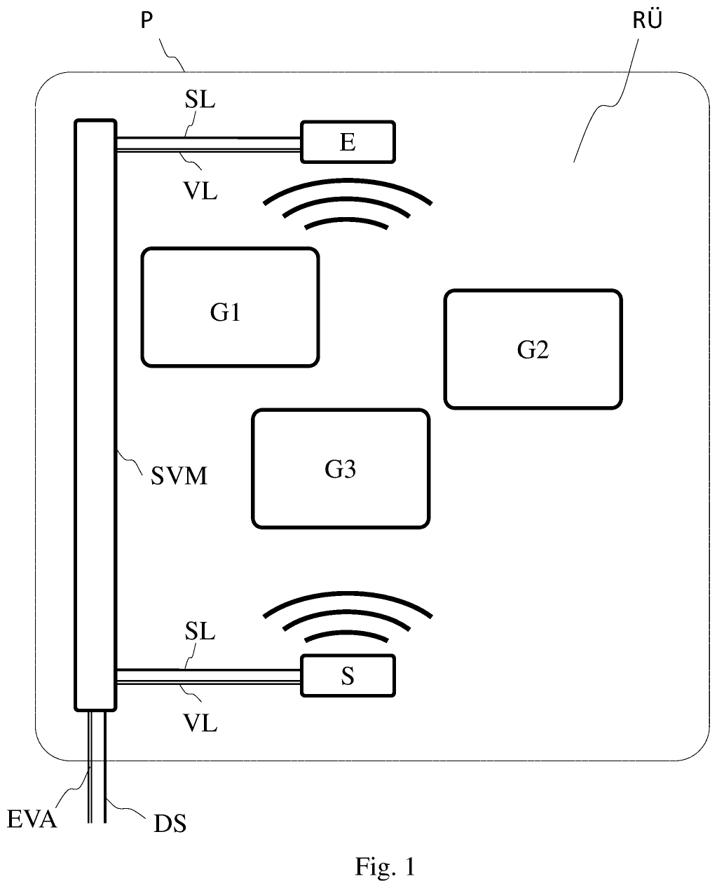

FIG. 1 shows a block diagram for explaining the method according to the invention and the device according to the invention, using the following reference signs:
RÜ Monitored space
P Perimeter of the monitored space
EVA Power supply connector
VL Supply lines
DS Detection signal interface
SL Signal lines
SVM Signal processing module
S Transmitter
E Receiver
G1 to G3 Objects or bodies 1 to 3

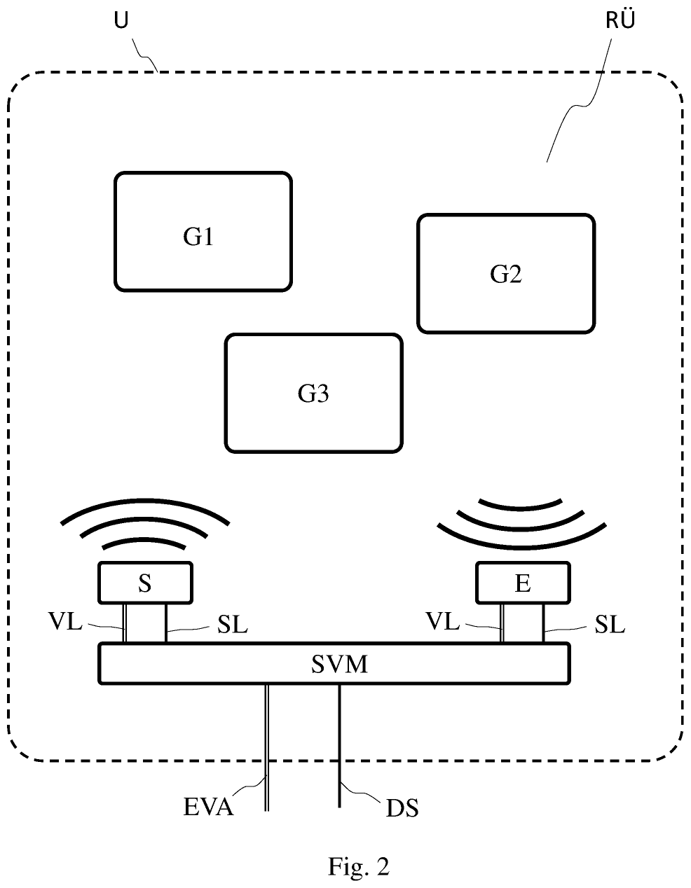

FIG. 2 shows the same block diagram as in FIG. 1, with the transmitter and the receiver no longer necessarily opposite one another, supplemented with a casing with an at least partly electrically conductive or metallic structure, using the following reference signs:
U Casing along the perimeter of the
   monitored space RÜ

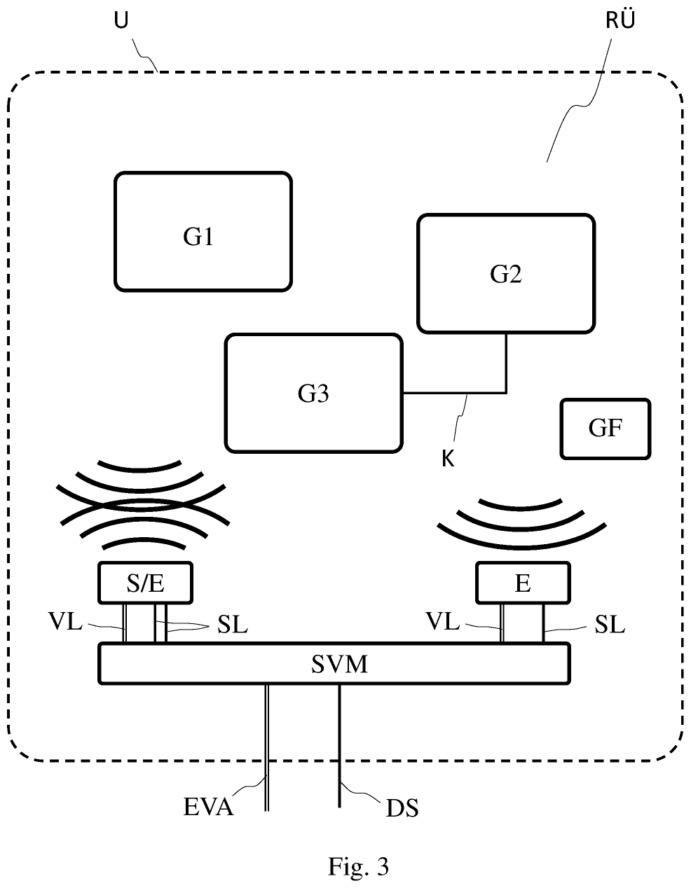

FIG. 3 shows the same block diagram as in FIG. 2, with a combined transceiver module S/E replacing the transmitter module S and, additionally, an object or body GF fixed according to the invention and a cable K fixed according to the invention, which connects the objects or bodies G2 and G3, being drawn, using the following reference signs:
S/E Combined transceiver module
GF Fixed object
K Fixed cable

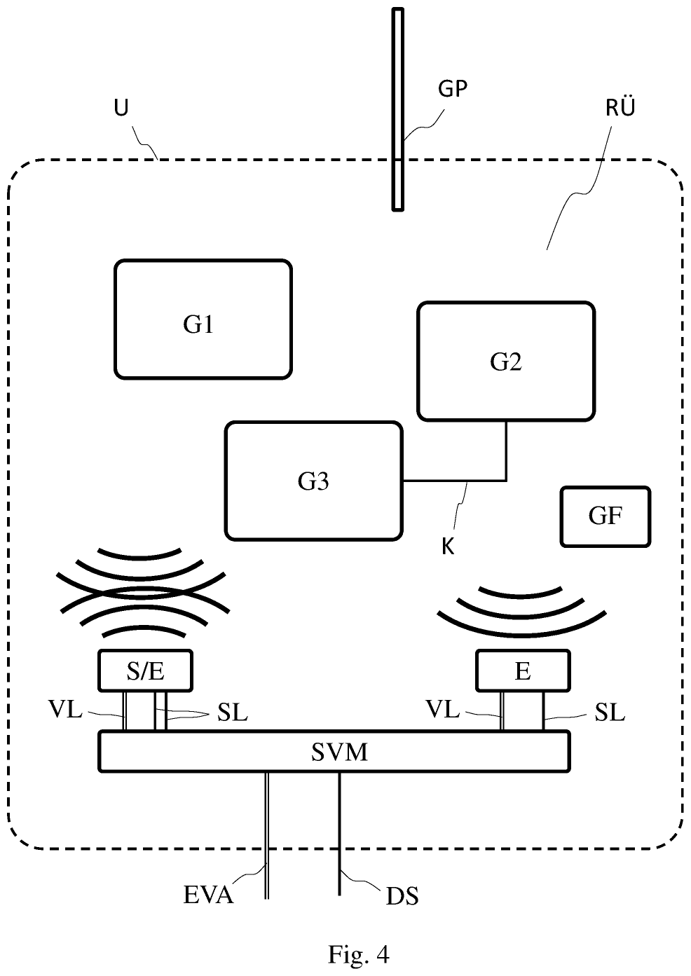

FIG. 4 shows the same block diagram as in FIG. 3, with an object or body GP penetrating the casing U being drawn, the latter serving to explain the detection according to the invention of the penetration of an object or body into the space to be monitored, using the additional reference sign:
GP Penetrating object or body

The monitored space RÜ outlined by the perimeter P shown in FIG. 1 contains objects or bodies G1, G2, G3, etc., the quality and arrangement of which in the monitored space RÜ determine the propagation of the electromagnetic waves, emitted by the transmitter S, through the monitored space RÜ to the receiver E. The arrangement of the transmitter S and the receiver E are chosen in exemplary fashion for this exemplary embodiment. It is also possible to use a plurality of transmitters and a plurality of receivers for the methods and devices according to the invention, which have a common oscillator or separate oscillators.

The objects or bodies G1, G2, G3, etc., influence the propagation of the waves depending on the wavelength of the electromagnetic waves, firstly by direct shadowing of the receiver, the absorptions, the transilluminations, the reflections, and the diffractions of the waves at the surfaces and edges of the objects or bodies G1, G2, G3, etc., and by the electrically conductive, dielectric or magnetically permeable structures of the objects or bodies G1, G2, G3, etc., in a manner determined by their arrangement and quality in the monitored space RÜ, which is described in radiofrequency engineering, for example, by what is known as the “bistatic” arrangement of the transmitter and receiver antennas with the complex scattering parameter “S21”.

In the case of very high frequencies, for example optical frequencies, of the electromagnetic waves, the arrangement according to the invention of the transmitter S and the receiver E is comparable to a photoelectric sensor, for example. However, at low frequencies of the electromagnetic waves which are advantageously used according to the invention for the detection of changes in the monitored space RÜ, for example frequencies in the range from approx. 1 GHz to approx. 1000 GHz, the shadowing effects are much less pronounced than in the case of optical frequencies, but the diffraction and transillumination effects are all the more pronounced in return.

The methods according to the invention and the devices according to the invention make use of these electromagnetic properties of the objects or bodies G1, G2, G3, etc., to the effect of the signals used to excite the transmitter antenna of the transmitter S being compared with the received signals of the receiver E with the aid of the signal processing module SVM supplied with operating power via the power supply connector EVA. Both the transmitter S and the receiver E are supplied with operating power via supply lines VL, and the signals for comparing the transmitted and received signals are transmitted to the signal processing module via the signal lines SL.

This comparison can be carried out digitally, for example by mixing the two signals on a non-linear electronic component and subsequently evaluating the mixed product in the baseband, or else after sampling the signals with a sampling signal which has a frequency or sampling rate chosen to be sufficiently high in accordance with the sampling theorem, following the quantization of the sampled signals and following the analog-to-digital conversion of the quantized values.

The result of the comparison of the transmitter signal or signals with the receiver signal or signals is recorded as the starting point at a first time. Any predefined threshold value-exceeding change in the comparison of the transmitter signal or signals with the receiver signal or signals at a later time triggers the detection signal DS as a result of the monitoring according to the invention in the signal processing module SVM.

The comparison of the transmitted and received signals can only be carried out according to the amplitude, the phase of the signals, or the amplitude and the phase. The oscillators of the transmitter and receiver can transmit and/or receive in continuous wave or modulated fashion. The modulation can be a frequency modulation, for example, with the advantage that a high resolution of the detection can be achieved by the signal processing module without high-energy pulses.

In the exemplary embodiment shown in FIG. 2, the perimeter of the monitored space RÜ coincides with a casing U that at least partly contains an electrically conductive or metallic structure. Reflections at the casing U of the electromagnetic waves emitted by the transmitter S lead to the formation of a field distribution in the monitored space RÜ that can be described as a standing wave, which even illuminates small and hidden corners in the arrangement and less pronounced changes in the electrically conductive, dielectric and/or magnetically permeable properties of the objects or bodies G1, G2, G3, etc. Changes in the arrangement and quality of the objects or bodies G1, G2, G3, etc., lead to a change in the field distribution and can be detected by the comparison, implemented by the signal processing module SVM, of the transmitted and received signals at different times before and after the change in the arrangement, the quality or the quantity of the objects or bodies.

Again, the arrangement of the transmitter S and the receiver E are chosen in exemplary fashion for this exemplary embodiment. It is also possible, as shown in FIG. 3, for a transmitter and receiver to be provided “monostatically” in a module S/E at the same position and with a common oscillator, and for one or more transmitters and one or more receivers for the methods and devices according to the invention to be used in combination with a common oscillator or with different oscillators. In radiofrequency engineering, the reception signals in this arrangement can be described by means of the complex scattering parameter “S11” as a function of the transmission signals. In addition to a monostatic arrangement of a transceiver pair S/E, a further receiver E is drawn in FIG. 3 by way of example.

The methods and devices according to the invention may be provided for rendering possible transportation of the objects or bodies encompassed by the casing U and of the components of transmitter S, receiver E or combined transceiver modules S/E and signal processing module, without the monitoring according to the invention of the space RÜ needing to be interrupted. Therefore, the invention provides for objects or bodies that could move due to the vibrations within the scope of transportation, and thus could trigger a detection signal contrary to one of the possible design purposes of the methods or devices according to the invention, to be fixed, as indicated in FIG. 3 by the fixed object GF, and a fixed cable between the object or body G2 and the object or body G3. Such fixing can be implemented for example, by mechanical clamps, applications of an adhesive, screwing, soldering, welding or similar fixing measures, with the result that the vibrations or remaining possible movements remain in a range that remains below the resolution limit, or are able to be filtered out by appropriate settings of threshold values in the signal processing module SVM. By fixing the objects or bodies provided in a monitored space RÜ, the methods and devices according to the invention can be set very sensitively or dimensioned for high sensitivity without unintended detection signals during transport of the overall object defined by the monitored space RÜ and the casing U being triggered by vibrations or other movements or deformations that could arise without the fixing according to the invention by forces that act on the objects G1, G2, G3, etc., and GF and possibly on cables K connecting the objects or bodies during transport.

FIG. 4 shows the same exemplary embodiment as FIG. 3, but additionally shows an object GP which protrudes through the casing U and hence penetrates into the monitored space RÜ. The electromagnetic field distribution that arises due to the objects or bodies G1, G2, G3, etc., GF and the fixed cable K, and the casing U is modified by the penetrating object GP. If the monitored space is penetrated by electrically conductive, dielectric or magnetically permeable materials, the comparison of the transmitted signal with the received signals of the receiver by the signal processing module SVM results in a detection signal which is available for various applications in technical systems, for example in data processing systems secured by casings such as the casing U.

For example, the penetrating objects can be tools used by attackers on environments protected by the casing U. In order to outwit a method according to the invention or a device according to the invention, the attacker could provide such a tool, for instance an electromagnetic probe for picking up signals from data transmission lines, for example with only very thin metal conductors and a low-dielectric plastic for reinforcement purposes. The attackers could moreover introduce such an electromagnetic probe, for example, only very slowly into the environment protected by the casing U. The high sensitivity of the methods and devices according to the invention, both in terms of the geometric dimensions of a change in the arrangement and the number of objects in the monitored space RÜ and in terms of small absolute-value changes in certain time periods, means that even such well thought-out attacks on the environments protected by the casing U trigger a detection signal according to the invention.

1. A method for detecting changes in a geometric arrangement, quality or quantity of electrically conductive, dielectric or magnetically permeable objects or bodies, wherein
(a) a signal processing module continuously compares the amplitudes of the electromagnetic wave-generating signals emitted by a transmitter and the signals received by a receiver, and
(b) the frequency of the waves emitted by the transmitter is chosen high enough so as not to disturb objects or apparatuses, optionally operating on electrical or electronic basis, within the space to be monitored but nevertheless achieve a high resolution, which is to say be able to detect and report even small geometric changes.

2. The method according to claim 1, wherein
(a) the wall encasing the space to be monitored has an at least partly electrically conductive or metallic structure and
(b) the frequency of the waves emitted by the transmitter is chosen so that all corners of the arrangement of the objects in the space to be monitored are illuminated by diffraction and reflections at the metallic structures of the casing.

3. The method according to claim 1, wherein the signal processing module also continuously compares the phases of the electromagnetic wave-generating signals emitted by a transmitter and the signals received by a receiver.

4. The method according to claim 1, wherein the electromagnetic waves emitted by the transmitter can not only be a continuous wave at a constant frequency but also have a modulation (e.g., frequency modulation) for a higher resolution.

5. A device for detecting changes in a geometric arrangement, quality or quantity of electrically conductive, dielectric or magnetically permeable objects or bodies, wherein the device is adapted to carry out a method for detecting changes in a geometric arrangement, quality or quantity of electrically conductive, dielectric or magnetically permeable objects or bodies.

6. The device according to claim 5, characterized in that an energy store within the space to be monitored can maintain the operation of the device during an optionally required transport and the accompanying disconnection from the power supply network.

7. The device according to claim 5, characterized in that the elastic or otherwise movable parts or parts of objects are fixed within the space to be monitored in such a way that movements during transport can no longer lead to changes, of order of the wavelength of the electromagnetic waves, in the pose or position of the objects or bodies within the space to be monitored.

8. The method according to claim 2, wherein the signal processing module also continuously compares the phases of the electromagnetic wave-generating signals emitted by a transmitter and the signals received by a receiver.

9. The method according to claim 2, wherein the electromagnetic waves emitted by the transmitter can not only be a continuous wave at a constant frequency but also have a modulation (e.g., frequency modulation) for a higher resolution.

10. The method according to claim 3, wherein the electromagnetic waves emitted by the transmitter can not only be a continuous wave at a constant frequency but also have a modulation (e.g., frequency modulation) for a higher resolution.

11. The device according to claim 6, characterized in that the elastic or otherwise movable parts or parts of objects are fixed within the space to be monitored in such a way that movements during transport can no longer lead to changes, of order of the wavelength of the electromagnetic waves, in the pose or position of the objects or bodies within the space to be monitored.
